(19) United States
(12) Patent Application Publication
(10) Pub. No.: US 2025/0135393 A1
(43) Pub. Date: May 1, 2025

(54) ENHANCEMENT OF CARBON DIOXIDE ABSORPTION CAPTURE WITH A FROTHING AGENT AND RELATED SYSTEMS AND METHODS

(71) Applicant: Michigan Technological University, Houghton, MI (US)

(72) Inventors: Surendra Komar KAWATRA, Fort Meyers, FL (US); Sriram VALLURI, Grayslake, IL (US)

(21) Appl. No.: 18/833,701

(22) PCT Filed: Jan. 26, 2023
(86) PCT No.: PCT/US2023/011646

§ 371 Date: Jul. 26, 2024

Related U.S. Application Data
(60) Provisional application No. 63/267,214, filed on Jan. 27, 2022.

(51) Int. Cl. B01D 53/14; B01D 53/62; B01D 53/78

(52) U.S. Cl. CPC B01D 53/1475; B01D 53/1493; B01D 53/62; B01D 53/78; B01D 2251/304; B01D 2251/606; B01D 2252/602; B01D 2257/504; B01D 2258/0283

(57) ABSTRACT

Sodium carbonate solutions utilized for CO₂ absorption of a gaseous feedstock, such as a flue gas, can be enhanced by a frothing agent as an additive, particularly polyglycol ether frothers. The presence of the frothing agent as an additive significantly increases the absorption rate of a sodium carbonate slurry solution to generate sodium bicarbonate. The frothing agent has minimal or no effect on the energy required for reagent regeneration, such that the forther-modified sodium carbonate solution based system is economically viable and environmentally friendly.

### CLAIM FOR PRIORITY

This application is as National Phase entry of PCT Application No. PCT/US2023/011646 filed Jan. 26, 2023, which claims the benefit of priority of U.S. Provisional Patent Application No. 63/267,214 filed Jan. 27, 2022, the subject matter of which are both incorporated by reference in their entirety.

### TECHNICAL FIELD

The present invention relates generally to the capture of contaminants from flue gas using an absorption column, particularly the chemical absorption capture of CO₂ using a scrubbing absorption column containing a slurry solution having a frothing agent.

### BACKGROUND

Flue gas emissions—the emitted material produced when fossil fuels such as coal, oil, natural gas, or wood are burned for heat or power—may contain pollutants, including carbon dioxide (CO₂), nitrogen oxides (NOₓ) and sulfur oxides (SOₓ). Capturing flue gasses from power plants is typically a multi-step process.

With current environmental regulations, CO₂ capture is very crucial for the survival of coal-fired power plants in the near future. Efforts to capture CO₂ at some power plants have been successful, but the cost of installing and operating the required equipment is high. As such, very few power plants have carbon capture and storage (CSS) systems. In order for the sale of captured CO₂ to become a profitable venture, the cost of capturing the CO₂ from a flue gas must be reduced.

Several post-combustion CO₂ capture technologies exist, such as chemical absorption, physical adsorption and membrane separation. Among all of these technologies, chemical absorption CO₂ capture is the most competitive and economically viable for CO₂ capture from fossil fuel fired power plants.

An efficient CCS process should have substantially lower operating costs compared to conventional aqueous absorbents without sacrificing effectiveness. Amines have been dominant in CO₂ capture research. However, the cost for thermal regeneration of amine reagents is high. Amines also present other problems, including: corrosion of equipment, fouling smell from equipment and reagent degradation due to the high volatility of amines. Although aqueous amine technology could easily scale-up to commercial plants, there is a need for alternative solvents to overcome the draw backs mentioned above.

Carbonate-based solvents have recently garnered attention, due to their low cost and non-corrosive nature. U.S. Pat. No. 7,919,064 first disclosed the capture and sequestration of CO₂ capture with an alkali metal carbonate or metal oxide, particularly containing an alkaline earth metal or iron, to form a carbonate salt, such as a dilute sodium carbonate solution. Later there were several improvements made for this process, most recently Barzagli et al. having tested dilute sodium carbonate solution for CO₂ capture and were able to achieve 80% CO₂ absorption efficiency.

However, the rate of absorption of CO₂ in carbonate solutions is limited at ambient temperature and is believed to be limited by the rate of physical mass transfer. Even at temperatures above 378 K, the reactions are not fast enough to make the absorption instantaneous.

In the chemical absorption process, flue gas enters the bottom of a column while a scrubbing solution is pumped to the top. The scrubbing solution is typically an alkaline solution suitable for the absorption of CO₂. The fluids interact in a packed bed, where the CO₂ is transported from the gaseous phase to the liquid phase. The absorbed CO₂ exits the bottom of the column either reacting or complexing with the absorbent.

After passing through the scrubbing column, the CO₂ loaded scrubbing solution should be regenerated for reuse. Commonly, the regeneration is performed by thermal decomposition. The CO₂ loaded solution is heated so as to reverse the absorption reaction between the absorbent and the CO₂. The resulting off-gas is a nearly pure CO₂ stream while the liquid phase is a solution of the regenerated absorbent. The regenerated scrubbing solution is then returned to the column.

The overall CO₂ absorption reactions with sodium carbonate, sodium hydroxide and amines are summarized in Equations (1)-(3), respectively.

Na₂CO_{3 (s)}+H₂O₍ₗ₎+CO_{2 (g)}→2NaHCO_{3 (aq)} (1)

NaOH_{(aq)}+CO_{2 (g)}→NaHCO_{3 (aq)} (2)

CO₂+RR′NH+H₂O↔(RR′NH₂⁺)(HCO₃⁻) (3)

Reagent make-up cost is one of the largest operating costs in post-combustion CO₂ capture. Table 1 shows the reagent cost and CO₂ loading capacity of amines, NaOH and sodium carbonate.

TABLE 1
Comparison of cost and CO₂ capture capacity
of different scrubbing solutions.

| | | Regeneration | Reagent | |
|---|---|---|---|---|
| | Capacity | Energy | Cost | Corrosion |
| Absorbent | (kg CO₂/kg | (MJ/Kg | ($/ton of | (pipes and |
| Type | absorbent) | CO₂) | reagent) | equipment) |
| Amines | 0.40 | 3.9-4.3 | 1400-1800 | Highly |
| (MEA, DEA) | | | | |
| Alkali | 0.55 | 3.5-3.9 | 400-450 | Yes due |
| Solution | | | | to high pH |
| (NaOH, KOH) | | | | |
| Sodium | 0.42 | 3.2-3.8 | 225-240 | Non-Corrosive |
| Carbonate | | | | |
| (Na₂CO₃) | | | | |

The reagent costs in Table 1 are 2020 $/ton prices from Alibaba. Sodium carbonate has the lowest cost and least regeneration energy compared to the other two reagents. The only drawback of sodium carbonate slurry is the slower absorption rate of CO₂ when compared to amines and NaOH, which will result in tall absorption columns for a sodium carbonate system. This slower absorption rate dictates that rate-increasing additives like surfactants are required for Na₂CO₃ slurry to be feasible for CO₂ capture. Previous literature suggests that hypochlorite, formaldehyde, piperazine (PZ), phenols, dextrose, diethanolamine (DEA), and monoethanolamine (MEA) will increase the absorption rate. However, one problem with these additives is that they will make the energy required for reagent regeneration higher. Another problem with these additives is that these additives also cause undesirable oxidative degradation and corrosion.

Accordingly, there is a need in the industry to decrease reagent cost for post-combustion CO₂ capture. There is also a need in the industry to provide reagents that can be utilized in a slurry solution that has an acceptable absorption rate of CO₂ capture. There is further a need in the industry to provide a slurry solution that utilizes low energy for reagent regeneration, such that the reagent can be recycled and reused for acceptable absorption of CO₂ capture. There is even further a need in the industry to provide a slurry solution that does not result in undesirable oxidative degradation and corrosion.

### SUMMARY

The present inventors have discovered an additive that will increase the absorption rate of a slurry solution comprising sodium carbonate and have minimal or no effect on the energy required for reagent regeneration. In some preferred aspects, the additive is a frother or frothing agent. In some other preferred aspects, the frothing agent is provided in a minimal concentration, such that the reagent cost of sodium carbonate and the additive is commercially acceptable.

The frothing agent can be utilized in a scrubber system according to certain aspects of the present invention, the scrubber system comprising a scrubbing column having a top end and a bottom end, wherein the scrubbing column comprises a slurry solution, wherein a gaseous mixture comprising carbon dioxide is fed into the bottom end of the scrubbing column, and wherein the slurry solution comprises at least one frothing agent.

In some aspects, the frothing agent comprises at least one compound of Formula (I):

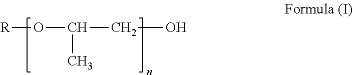

wherein R is H or CH₃, and wherein n is greater than 2 and up to 34, preferably n being between 3 and 34, more preferably n being between 3 and 8.

In some aspects, the frothing agent comprises at least one compound of Formula (I), wherein the molecular weight (g/mol) is less than about 400, in some aspects less than about 390, in some aspects less than about 380, in some aspects less than about 370, in some aspects less than about 360, in some aspects less than about 350, in some aspects less than about 340, in some aspects less than about 330, in some aspects less than about 320, in some aspects less than about 310, in some aspects less than about 300, in some aspects less than about 290, in some aspects less than about 280, in some aspects less than about 270, in some aspects less than about 260, and in some aspects less than about 250.

In some aspects, the frothing agent comprises at least one compound of Formula (I), wherein the molecular weight (g/mol) is greater than 200 and less than about 400, in some aspects is greater than 200 and less than about 390, in some aspects is greater than 200 and less than about 380, in some aspects is greater than 200 and less than about 370, in some aspects is greater than 200 and less than about 360, in some aspects is greater than 200 and less than about 350, in some aspects is greater than 200 and less than about 340, in some aspects is greater than 200 and less than about 330, in some aspects is greater than 200 and less than about 320, in some aspects is greater than 200 and less than about 310, in some aspects is greater than 200 and less than about 300, in some aspects is greater than 200 and less than about 290, in some aspects is greater than 200 and less than about 280, in some aspects is greater than 200 and less than about 270, in some aspects is greater than 200 and less than about 260, and in some aspects is greater than 200 and less than about 250.

In some aspects, the frothing agent comprises at least one poly glycol ether (PEG)-based compound.

In some aspects, the frothing agent comprises at least one PEG-based compound chosen from the group consisting of CH₃(C₃H₆O)₃OH, CH₃(C₃H₆O)₄OH, CH₃(C₃H₆O)_{6.3}OH, CH₃(C₃H₆O)₃OH, H(C₃H₆O)_{6.5}OH, H(C₃H₆O)₆OH, CH₃(C₃H₆O)₄OH(C₄H₈O), H(C₃H₆O)_{12.8}OH, H(C₃H₆O)_{16.5}OH, H(C₃H₆O)₃₄OH and mixtures thereof.

In some aspects, the frothing agent comprises at least one PEG-based compound chosen from the group consisting of CH₃(C₃H₆O)₃OH, CH₃(C₃H₆O)₄OH, and combinations thereof.

In some aspects, the frothing agent comprises at least one PEG-based compound, wherein the PEG-based compound is capable of producing an average bubble diameter size in a slurry solution of less than 1.8 mm, preferably less than 1.7 mm, preferably less than 1.6 mm, more preferably less than 1.5 mm, preferably less than 1.4 mm, and even more preferably less than 1.4 mm.

In some aspects, the frothing agent is capable of producing an average bubble diameter size in a slurry solution between about 0.9 mm up to about 2.0 mm, preferably between about 1.0 mm up to about 1.9 mm, preferably between about 1.0 mm up to about 1.8 mm, preferably between about 1.0 mm up to about 1.7 mm, preferably between about 1.0 mm up to about 1.6 mm, preferably between about 1.0 mm up to about 1.5 mm, preferably between about 1.0 mm up to about 1.4 mm, preferably between about 1.0 mm up to about 1.3 mm, and even more preferably between about 1.0 mm up to about 1.2 mm.

In some aspects, the frothing agent is present in a slurry solution in an amount greater than 0 ppm up to about 40 ppm, preferably between about 1 ppm and about 35 ppm, preferably between about 2 ppm and about 30 ppm, more preferably between about 3 ppm and about 25 ppm, and even more preferably between about 5 ppm and about 20 ppm.

In some aspects, the frothing agent comprises at least one PEG-based compound having a molecular weight (g/mol) less than about 400, in some aspects less than about 390, in some aspects less than about 380, in some aspects less than about 370, in some aspects less than about 360, in some aspects less than about 350, in some aspects less than about 340, in some aspects less than about 330, in some aspects less than about 320, in some aspects less than about 310, in some aspects less than about 300, in some aspects less than about 290, in some aspects less than about 280, in some aspects less than about 270, in some aspects less than about 260, and in some aspects less than about 250.

In some aspects, the frothing agent comprises at least one PEG-based compound having a molecular weight (g/mol) greater than 200 and less than about 400, in some aspects is greater than 200 and less than about 390, in some aspects is greater than 200 and less than about 380, in some aspects is greater than 200 and less than about 370, in some aspects is greater than 200 and less than about 360, in some aspects is greater than 200 and less than about 350, in some aspects is greater than 200 and less than about 340, in some aspects is greater than 200 and less than about 330, in some aspects is greater than 200 and less than about 320, in some aspects is greater than 200 and less than about 310, in some aspects is greater than 200 and less than about 300, in some aspects is greater than 200 and less than about 290, in some aspects is greater than 200 and less than about 280, in some aspects is greater than 200 and less than about 270, in some aspects is greater than 200 and less than about 260, and in some aspects is greater than 200 and less than about 250.

In some aspects, the slurry solution comprises sodium carbonate.

In some aspects, the scrubbing column is a counter current absorption column.

In some aspects, the scrubber system reacts the sodium carbonate of the slurry solution with the CO₂ of the gaseous mixture to provide a sodium bicarbonate solution.

In some aspects, the sodium bicarbonate solution produced in the scrubbing column can be subjected to a regeneration process to provide a regenerated sodium carbonate solution and a regenerated carbon dioxide. In some aspects, the regenerated carbon dioxide is essentially pure. In some aspects, the regenerated carbon dioxide is a gas or liquid. In some aspects, the regenerated carbon dioxide has a purity greater than 95%, in some aspects greater than 97%, in some aspects greater than 98%, in some aspects greater than 99%, in some preferably aspects greater than 99.5%, and in some more preferable aspects greater than 99.9%.

In some aspects, the regenerated sodium carbonate solution is separated from the regenerated carbon dioxide.

In some aspects, the regenerated sodium carbonate solution is recycled through the scrubbing column.

In some aspects, the regenerated sodium carbonate solution is capable of reacting with the CO₂ of the gaseous mixture fed into the scrubber column to provide a second sodium bicarbonate solution.

In some aspects, the regenerated sodium carbonate solution fed to the scrubbing column, reaction of the CO₂ of the gaseous mixture fed into the scrubber column with the regenerated sodium carbonate solution to provide a sodium bicarbonate solution, and the sodium bicarbonate solution being subjected to a regeneration process to provide a second regenerated sodium carbonate solution, the second regenerated sodium carbonate solution separated from the regenerated CO₂, such that any of the regenerated sodium carbonate solution fed back to the scrubbing column to provide additional sodium bicarbonate for regeneration of a subsequent regenerated sodium carbonate solution and regenerated CO₂ is a continuous process comprising one or more regeneration cycles.

In some aspects, the regenerated sodium carbonate solution comprises at least a portion of the frothing agent concentration.

In some aspects, the frothing agent concentration is replenished in the sodium carbonate solution with a fresh aliquot of frothing agent after about 2 to about 10 cycles, in some aspects after about 2 to about 6 cycles, and in some aspects between about 3 and about 4 cycles.

In some aspects, the scrubber system further comprising a vessel for regenerating the sodium carbonate and the CO₂ from the sodium bicarbonate solution from the scrubber column, the vessel preferably being a flash drum.

In some aspects, the scrubber system further comprising a condenser operably connected to the vessel.

In some aspects, the scrubber system further comprises a heat cycle loop, wherein the heat cycle loop is configured to provide input heat from a heat source, preferably steam, and the resultant sodium bicarbonate solution from the scrubbing column is preheated by the regenerated sodium carbonate solution from the flash drum, such that the regenerated sodium carbonate is cooled prior to being fed back into the scrubbing column.

In some aspects, CO₂ capture of at least 90% is achieved, in some aspects at least 95%, in some aspects at least 98%, in some aspects at least 99%, in some aspects at least 99.5%, and in some aspects at least 99.9%.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A-1D are schematics illustrating the effects of a frothing agent adsorbing on the liquid-air interface of bubbles to reduce the surface tension and thereby decreasing the bubble size, according to certain embodiments of the present invention. FIG. 1A illustrates the effect on bubble generation without a frothing agent, while FIG. 1B illustrates the effect on bubble generation with a frothing agent (arrows in FIGS. 1A-IB indicating the flow direction of the bubbles). FIGS. 1C-ID illustrate more specifically the effect of a frothing agent on a single carbon dioxide bubble generation with the frothing agent adsorbing to the carbon dioxide bubble with the polar hydrocarbon group of the frothing agent absorbed at the gas-liquid interface and the non-polar group of the frothing agent oriented towards the gas portion of the carbon dioxide bubble.

FIG. 2 is a process flow diagram for a scrubber system comprising a scrubber assembly for CO₂ capture and a regeneration assembly for regenerating reagents and CO₂ in a purified form, the scrubber system capable of providing a continuous-loop of CO₂ capture from a gaseous feedstock using a slurry scrubbing solution in the scrubber assembly to produce a resultant product, and the regeneration assembly capable of transforming the resultant product into regenerated CO₂ in a purified form and a regenerated slurry scrubbing solution, according to certain embodiments of the present invention. The gaseous feedstock preferably comprising CO₂ mixed with air can be fed into the scrubbing column from a gas inlet, preferably proximate a bottom portion of the scrubbing column, and the slurry scrubbing solution is fed into the scrubbing column from a slurry solution inlet, preferably proximate a top portion of the scrubbing column, whereby a counter-current direction between the slurry scrubbing solution and the air flow (CO₂/air mixture) is provided within the scrubbing column. After CO₂ is absorbed by the slurry scrubbing solution (in some aspects preferably comprising a sodium carbonate solution), the resultant reactant solution (in some aspects preferably comprising a sodium bicarbonate solution) exits the scrubbing column at a resultant product outlet, preferably proximate a bottom portion of the scrubbing column. The resultant reactant solution exiting the scrubbing column can be optionally preheated by a regenerated slurry scrubbing solution (in some aspects preferably comprising a sodium carbonate solution) returning to the scrubbing column. The regenerated slurry scrubbing solution preferably returning to the scrubbing column from a flash drum, which as a result of the heat transfer between with the resultant production cools the regenerated scrubbing solution before the regenerated scrubbing solution being pumped back into the scrubbing column. The resultant reactant solution preheated by the regenerated scrubbing solution can be fed into a regenerator, preferably a flash drum proximate a feed inlet, wherein the resultant reactant solution is transformed back into the regenerated slurry scrubbing solution and regenerated CO₂ provided in purified form compared to the gaseous feedstock, whereby the regenerated slurry scrubbing solution and regenerated CO₂ can be separated from each other, with the regenerated slurry scrubbing solution capable of being recycled and reused in the scrubbing column to capture additional CO₂ from a continual flow of gaseous feedstock.

FIG. 3 is a schematic of an exemplary heat cycle loop provided by the CO₂ capture scrubber and regeneration system of FIG. 2, whereby input heat can be provided by steam (the regeneration process is omitted from the view but would take place in-line with the 98° C. stream), according to certain embodiments of the present invention.

FIG. 4 is a graph illustrating the calculated percentage of CO₂ absorbed by three different scrubbing solutions over time until steady state and a maximum absorbance was achieved using the system of FIG. 2, which included 0.2 M scrubbing solutions of (i) Na₂CO₃, (ii) NaOH and (iii) MEA, each scrubbing solution concentration at 38.5° C., with the error bars representing standard error, wherein in the first 3 minutes from the start of experiment the percentage of CO₂ absorbed in the instance of the scrubbing solution being MEA and NaOH rises to about 80-85% very fast and then finally reaching a maximum value of about 97% after 5 minutes, and the scrubbing solution being Na₂CO₃ the percentage of CO₂ absorbed gradually increases to about 36% in the first 3 minutes and reaches asymptote at about 55.6% after 5 minutes, indicating that the absorption efficiency of Na₂CO; is much less compared to the other two scrubbing solutions, according to certain embodiments of the present invention.

FIG. 5 is a graph illustrating the CO₂ absorption efficiency of a 0.2 M Na₂CO₃ scrubber solution being enhanced with a frothing agent at 10 ppm frother concentration at 38.5° C., with the error bars representing standard error, wherein in the first 2 minutes the percentage of CO₂ absorbed reaches about 93% in the instance of the frothing agent being DF200, and wherein a maximum value of about 99.9% after 5 minutes is reached in the instance of the frothing agent being DF200, DF250 or AF68, and wherein the frothing agent being AF70 or DF400 only able achieve a maximum absorbance of about 62.8%, according to certain embodiments of the present invention.

FIG. 6 is a graph illustrating the estimated CO₂ bubble size distribution in a scrubber solution comprising sodium carbonate solution with different frothing agents, whereby the estimated CO₂ bubble size in diameter and frequency count for each of the frothing agents AF68, DF200, AF70, DF400 and DF250, wherein the frothing agent DF200 provided the smallest and most uniform bubble size distribution compared to the other frothing agents, wherein the frothing agents DF250 and AF68 provided similar size distributions, and wherein the frothing agents AF70 and DF400 provide the largest bubble sizes, such that a frothing agent providing a narrow size distribution and smaller CO₂ bubble size provided more effective mass transfer area, according to certain embodiments of the present invention.

FIG. 7 is a graph illustrating the effect of frothing agent concentration in a scrubbing solution on CO₂ absorption performance, wherein concentrations of 15 ppm, 10 ppm and 5 ppm for the frothing agent DF200 were provided in 0.2 M sodium carbonate solution at 38.5° C., the error bars representing standard error, whereby the frothing agent concentrations of ppm and 15 ppm showed similar absorption performance, reaching a maximum value of about 99.9%, and the frothing concentration of 5 ppm only achieving a 70.3% maximum 10 absorbance, according to certain embodiments of the present invention.

FIG. 8 is a graph illustrating the rate of absorption of CO₂ with a scrubbing solution comprising 0.2 M Na₂CO₃ and various different frothing agents at different concentrations, with the error bars representing standard error, according to certain embodiments of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The term “slurry solution” as used herein refers to a liquid-solid fluid mixture with a specific gravity greater than 1.

The term “frother” or “frothing agent” as used herein refers to a reagent used to control the size and stability of one or more gas bubbles in a liquid, preferably the bubbles comprising air and/or CO₂. In some instances, a “frother” or “frothing agent” is an organic heteropolar compound, such as an alcohol or polyglycol ether, that due to its heteropolar nature absorbs at the gas/liquid interface and as a result, lowers the surface tension, which has the effect of producing smaller bubbles than the bubbles produced in the absence of the “frother” or “frothing agent”. In some preferable aspects, the “frother” or “frothing agent” minimizes or prevents bubble coalescence, which minimizes bubbles from becoming bigger and thereby producing uniformly small sized bubbles.

With current environmental regulations, CO₂ capture is very crucial for the survival of fossil-fuel power plants, particularly coal-fired power plants in the near future. The present inventors investigated CO₂ absorption performances of Na₂CO₃, NaOH, Monoethanolamine (MEA) and frother-enhanced Na₂CO₃ slurry solutions in a gas-liquid countercurrent column. A frothing agent was added to the slurry solution comprising sodium carbonate in order to increase the surface area available for CO₂ transport within the packed bed. Generally speaking, the presence of the frothing agent in the slurry solution comprising sodium carbonate increased the CO₂ capture efficiency of dilute sodium carbonate slurry from 55.6% to 99.9%, before reaching saturation.

Without wishing to be bound by theory, it is believed that increasing the mass transfer kinetics by the addition of a frothing agent to the slurry solution increased the CO₂ absorption efficiency of sodium carbonate. The enhancement of the CO₂ absorption efficiency by the frothing agent was dramatic, with the increased efficiency provided by the frothing agent allowing even dilute sodium carbonate solutions to achieve greater than 80%, in some aspects greater than 85%, in some aspects greater than 90%, in some aspects greater than 95%, in some aspects greater than 97.5%, in some aspects greater than 98%, in some aspect greater than 98.5%, in some aspects greater than 99.0%, in some aspects greater than 99.5%, in some aspect greater than 99.75%, and in some aspects up to 99.9%, CO₂ capture.

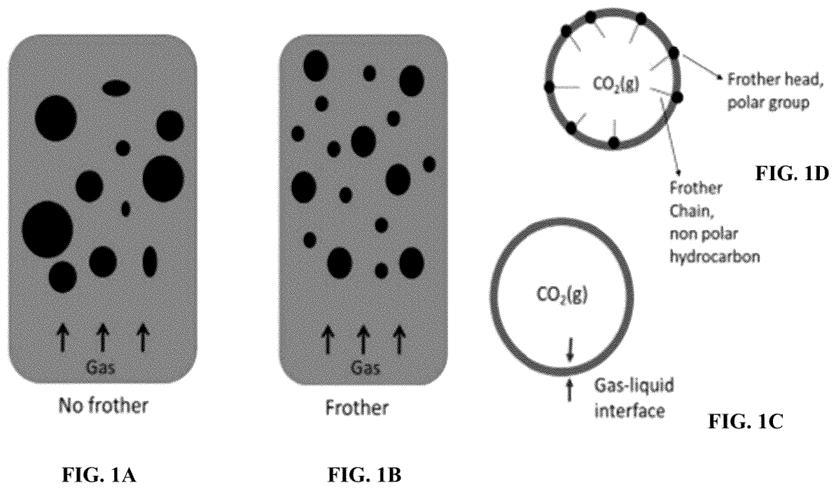

Frothers or frothing agents are surfactants that adsorb on the liquid-air interface of the bubbles, reducing the surface tension and thereby decreasing the bubble size as shown in FIGS. 1A-ID. The CO₂ absorption rate of sodium carbonate is low compared to NaOH and MEA, which is believed to be due to limited kinetics from the low concentration of CO₂ in aqueous solution. The present inventors have discovered that one way to overcome this obstacle is to increase the rate of physical mass transfer, which can be achieved by creating smaller and uniform bubbles. This decrease in size increases the interfacial interaction area between gas and liquid increasing the mass transfer rate and allowing more gas to be absorbed faster.

Bubble size can be influenced by adding surfactants known as frothers. Frothers or frothing agents can prevent bubble coalescence, which stops the bubbles from becoming bigger and thereby producing tiny and uniform bubbles. Frothing agents have a polar hydrocarbon group and a non-polar group, with the non-polar group being oriented towards the air and the polar group adsorbed at the air-liquid interface as shown in FIG. 1D.

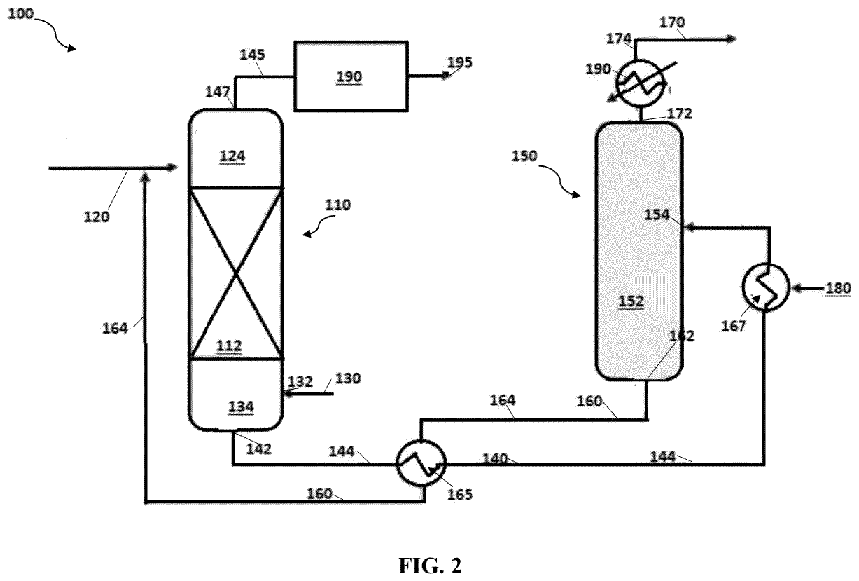

In certain aspects, a frothing agent can be utilized in a scrubber system, such as a scrubbing column as shown in FIG. 2. The scrubber system preferably comprises a scrubbing column having a top end and a bottom end, wherein the scrubbing column comprises a slurry solution, wherein a gaseous mixture comprising carbon dioxide is fed into the bottom end of the scrubbing column, and wherein the slurry solution comprises at least one frothing agent.

In some aspects, the frothing agent comprises at least one compound of Formula (I):

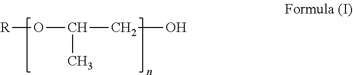

wherein R is H or CH₃, and wherein n is greater than 2 and up to 34, preferably n being between 3 and 34, more preferably n being between 3 and 8.

The frothing agent preferably comprises at least one compound of Formula (I), wherein the molecular weight (g/mol) is less than about 400, in some aspects less than about 390, in some aspects less than about 380, in some aspects less than about 370, in some aspects less than about 360, in some aspects less than about 350, in some aspects less than about 340, in some aspects less than about 330, in some aspects less than about 320, in some aspects less than about 310, in some aspects less than about 300, in some aspects less than about 290, in some aspects less than about 280, in some aspects less than about 270, in some aspects less than about 260, and in some aspects less than about 250.

In some aspects, the frothing agent comprises at least one compound of Formula (I), wherein the molecular weight (g/mol) is greater than 200 and less than about 400, in some aspects is greater than 200 and less than about 390, in some aspects is greater than 200 and less than about 380, in some aspects is greater than 200 and less than about 370, in some aspects is greater than 200 and less than about 360, in some aspects is greater than 200 and less than about 350, in some aspects is greater than 200 and less than about 340, in some aspects is greater than 200 and less than about 330, in some aspects is greater than 200 and less than about 320, in some aspects is greater than 200 and less than about 310, in some aspects is greater than 200 and less than about 300, in some aspects is greater than 200 and less than about 290, in some aspects is greater than 200 and less than about 280, in some aspects is greater than 200 and less than about 270, in some aspects is greater than 200 and less than about 260, and in some aspects is greater than 200 and less than about 250.

In some aspects, the frothing agent comprises at least one poly glycol ether (PEG)-based compound.

In some aspects, the frothing agent comprises at least one PEG-based compound chosen from the group consisting of CH₃(C₃H₆O)₃OH, CH₃(C₃H₆O)₄OH, CH₃(C₃H₆O)_{6.3}OH, CH₃(C₃H₆O)₃OH, H(C₃H₆O)_{6.5}OH, H(C₃H₆O)₆OH, CH₃(C₃H₆O)₄OH(CH₈O), H(C₃H₆O)_{12.8}OH, H(C₃H₆O)_{16.5}OH, H(C₃H₆O)₃₄OH and mixtures thereof.

In some aspects, the frothing agent comprises at least one PEG-based compound chosen from the group consisting of CH₃(C₃H₆O)₃OH, CH₃(C₃H₆O)₄OH, and combinations thereof.

In some aspects, the frothing agent comprises at least one PEG-based compound, wherein the PEG-based compound is capable of producing an average bubble diameter size in a slurry solution of less than 1.8 mm, preferably less than 1.7 mm, preferably less than 1.6 mm, more preferably less than 1.5 mm, preferably less than 1.4 mm, and even more preferably less than 1.4 mm.

In some aspects, the frothing agent is capable of producing an average bubble diameter size in a slurry solution between about 0.9 mm up to about 2.0 mm, preferably between about 1.0 mm up to about 1.9 mm, preferably between about 1.0 mm up to about 1.8 mm, preferably between about 1.0 mm up to about 1.7 mm, preferably between about 1.0 mm up to about 1.6 mm, preferably between about 1.0 mm up to about 1.5 mm, preferably between about 1.0 mm up to about 1.4 mm, preferably between about 1.0 mm up to about 1.3 mm, and even more preferably between about 1.0 mm up to about 1.2 mm.

The frothing agent is preferably present in the slurry solution in an amount greater than 0) ppm up to about 40 ppm, preferably between about 1 ppm and about 35 ppm, preferably between about 2 ppm and about 30 ppm, more preferably between about 3 ppm and about 25 ppm, and even more preferably between about 5 ppm and about 20 ppm.

The frothing agent preferably comprises at least one PEG-based compound having a molecular weight (g/mol) less than about 400, in some aspects less than about 390, in some aspects less than about 380, in some aspects less than about 370, in some aspects less than about 360, in some aspects less than about 350, in some aspects less than about 340, in some aspects less than about 330, in some aspects less than about 320, in some aspects less than about 310, in some aspects less than about 300, in some aspects less than about 290, in some aspects less than about 280, in some aspects less than about 270, in some aspects less than about 260, and in some aspects less than about 250.

In some aspects, the frothing agent preferably comprises at least one PEG-based compound having a molecular weight (g/mol) greater than 200 and less than about 400, in some aspects is greater than 200 and less than about 390, in some aspects is greater than 200 and less than about 380, in some aspects is greater than 200 and less than about 370, in some aspects is greater than 200 and less than about 360, in some aspects is greater than 200 and less than about 350, in some aspects is greater than 200 and less than about 340, in some aspects is greater than 200 and less than about 330, in some aspects is greater than 200 and less than about 320, in some aspects is greater than 200 and less than about 310, in some aspects is greater than 200 and less than about 300, in some aspects is greater than 200 and less than about 290, in some aspects is greater than 200 and less than about 280, in some aspects is greater than 200 and less than about 270, in some aspects is greater than 200 and less than about 260, and in some aspects is greater than 200 and less than about 250.

Besides the frothing agent, the slurry solution further preferably comprises sodium carbonate.

As shown by the process flow diagram in FIG. 2, scrubber system 100 generally comprises scrubber assembly 110 and optionally a regeneration assembly 150. Scrubber assembly 110 preferably comprises scrubbing column 112, which contains slurry scrubbing solution 120 and gaseous feedstock 130. Slurry scrubbing solution 120 is preferably fed into scrubbing column 112 proximate a slurry solution inlet 122, which is preferably proximately located a top portion 124 of scrubbing column 112. Slurry scrubbing solution 120 can comprise fresh slurry scrubbing solution, regenerated slurry scrubbing solution, or a mixture thereof. Gaseous feedstock 130 preferably comprises a mixture of CO₂ and air, which is preferably fed into scrubbing column 112 proximate a gas inlet 132, which is preferably proximately located a bottom portion 134 of scrubbing column 112. Scrubbing column 112 is preferably a packed-bed counter-current absorption column, such that the flow of slurry scrubbing solution 120 is in an opposite direction to the flow of gaseous feedstock 130.

Slurry scrubbing solution 120 and gaseous feedstock 130 are each preferably fed into scrubbing column 112, such that scrubber assembly 110 is capable of providing continuous CO₂ capture. During normal operation, CO₂ is absorbed from gaseous feedstock 130 by slurry scrubbing solution 120 providing resultant product 140, which is preferably a resultant product solution, configured to exit scrubbing column 112 proximate at a resultant product outlet 142, preferably proximately located bottom portion 134 of scrubbing column 112, providing resultant product stream 144. Resultant product 140 having exited scrubbing column 112 can optionally be subjected to one or more further processing processes.

For instance, resultant product 140 can be subjected to an optional heat transfer process. In one instance, resultant product stream 144 can be preheated by regenerated scrubbing solution stream 164 in a heat exchanger 165, wherein regenerated scrubbing solution stream 164 returning to scrubber assembly 110 prior to regenerated scrubbing solution 160 being fed back into scrubber column 112 via scrubber slurry solution inlet 122. Regenerated scrubbing solution stream 164 can have a higher temperature than resultant product stream 144, such that heat exchange between resultant product stream 144 and regenerated scrubbing solution stream 164 can cool a temperature of the regenerated scrubbing solution stream 164 before regenerated scrubbing solution 160 is fed back into scrubbing column 112. In another instance, resultant product 140 can be heated in via heat exchanger 167 by heat source 180. Preferably, heat source 180 is steam (e.g., 30 psi steam) such as to raise the temperature of resultant product 140 to an increased temperature, such as to a temperature greater than 90° C., in some aspects greater than 95° C., in some aspects greater than 96° C., in some aspects up to about 98° C., although other sources of heat can be used to heat resultant product 140. In some preferred aspects, resultant product 140 is preheated one or more times prior to being fed into regeneration assembly 150.

Resultant product 140 can be subjected to an optional regeneration process. Resultant product stream 144 can be fed into regeneration assembly 150 comprising a regeneration vessel 152 via a regeneration feed inlet 154. Regeneration vessel 152 preferably comprises a flash drum. Once resultant product stream 144 is fed into regeneration vessel 152, resultant product 140 is transformed into regenerated slurry scrubbing solution 160 and regenerated CO₂ 170, which can be separated from each other. Regenerated CO₂ 170 can exit regeneration vessel 152 via a gas outlet 172, preferably providing a continuous regenerated CO₂ stream 174, which is preferably a purified form of CO₂. Regenerated slurry scrubbing solution 160 can exit regeneration vessel 152 via regeneration solution outlet 162, providing regenerated scrubbing solution stream 164. Regenerated scrubbing solution stream 164 is preferably recycled back to scrubbing assembly 110 and reused as a slurry scrubbing solution for capture of additional CO₂.

As provided by the foregoing disclosure in relation to FIG. 2, the scrubbing assembly 110 and regeneration assembly 150 can provide a continuous loop between resultant product 140 being transformed into regenerated slurry scrubbing solution 160, such that the input gaseous feedstock 130 is converted into regenerated CO₂ 170 as an output, which can be subjected to a condenser 190, which condenses the regenerated CO₂ 170 in a purified form to provide condensed CO₂ in a purified form. Another output comprises outlet gas stream 145 having CO₂ absorbed within scrubbing column 112, such that gas stream 145 exits scrubbing column via gas outlet 147. Outlet gas stream 145 is preferably cleaned with respect to CO₂, which can be subjected to gas analysis by a gas analyzer 190, and removed into the atmosphere as cleaned exhaust 195.

In some aspects, slurry scrubbing solution 120 comprises sodium carbonate, such that the scrubber system reacts the sodium carbonate of the slurry solution with the CO₂ of the gaseous mixture to provide a resultant product preferably comprising a sodium bicarbonate solution. In some preferred aspects, regenerated slurry scrubbing solution 160 comprises sodium carbonate, such that the scrubber system reacts the sodium carbonate of the regenerated slurry solution with the CO₂ of the gaseous mixture to provide a resultant product preferably comprising a sodium bicarbonate solution.

In some aspects, the sodium bicarbonate solution produced in the scrubbing column can be subjected to a regeneration process to provide a regenerated sodium carbonate solution and a regenerated carbon dioxide, which is provided in a purified form compared to the CO₂ of the gaseous mixture introduced into the scrubbing column. In some aspects, the regenerated carbon dioxide is essentially pure. In some aspects, the regenerated carbon dioxide is a gas or liquid. In some aspects, the regenerated carbon dioxide has a purity greater than 95%, in some aspects greater than 97%, in some aspects greater than 98%, in some aspects greater than 99%, in some preferably aspects greater than 99.5%, and in some more preferable aspects greater than 99.9%.

In some preferred aspects, the resultant product is separated into a regenerated slurry solution and a regenerated carbon dioxide, preferably within a flash drum. In some preferred aspects, the regenerated slurry solution comprises a sodium carbonate solution. The regenerated slurry solution can be recycled, such that it is cycled back through the scrubbing column to provide further capture of CO₂ from a gaseous feedstock introduced into the scrubbing column. In some aspects, the regenerated slurry solution, such as a regenerated sodium carbonate solution, is capable of reacting with the CO₂ of the gaseous mixture fed into the scrubber column to provide a second resultant product, such as a second sodium bicarbonate solution.

In some aspects, the regenerated sodium carbonate solution fed to the scrubbing column, reaction of the CO₂ of the gaseous mixture fed into the scrubber column with the regenerated sodium carbonate solution to provide a sodium bicarbonate solution, and the sodium bicarbonate solution being subjected to a regeneration process to provide a second regenerated sodium carbonate solution that is separated from the regenerated CO₂, can be provided as a continuous process.

In the continuous process, the gaseous mixture fed into the scrubbing solution can be consumed within the scrubbing column by reacting the slurry scrubber solution with CO₂ of the gaseous mixture to produce a resultant product, thereby allowing other air components to vent out of the scrubbing column. The resultant product can be further processed to produce purified CO₂ and regenerate the slurry scrubbing solution for additional use within the scrubbing column. For instance, any regenerated sodium carbonate solution fed back to the scrubbing column allows for additional CO₂ capture to provide a resultant sodium bicarbonate, which can be subjected to processing for regeneration of a subsequent regenerated sodium carbonate solution and purified CO₂, which can be a continuous process comprising one or more regeneration cycles.

In some aspects, the regenerated slurry solution, preferably comprising a sodium carbonate solution, comprises at least a portion of the frothing agent concentration. The frothing agent concentration may need to be replenished after a certain number of regeneration cycles. In some aspects, the frothing agent concentration is replenished in the sodium carbonate solution with a fresh aliquot of frothing agent after about 2 to about 10 cycles, in some aspects after about 2 to about 6 cycles, and in some aspects between about 3 and about 4 cycles.

In some aspects, the slurry solution and/or the regenerated slurry solution comprising one or more frothing agents providing CO₂ capture of at least 90%, in some aspects at least 95%, in some aspects at least 98%, in some aspects at least 99%, in some aspects at least 99.5%, and in some aspects at least 99.9%.

### Experimental

### Column Properties

A CO₂ capture system was designed and built as shown in FIG. 2 having a scrubbing column with a gas inlet, resultant product outlet, and gas outlet, whereby the result product outlet is shown as being in fluid communication with a means for regeneration of a slurry solution and CO₂, such as a flash drum. The CO₂ capture system also can have a heat recycle loop in fluid communication between the scrubbing column and the means for regeneration, a condenser in fluid communication with the means for regeneration, and a heat inlet into the system.

As it relates to the scrubber column, polypropylene pall rings (1.2 cm×1.2 cm) were used as packing in the scrubber column. The height of a packed bed scrubbing column (Z) was calculated using the contact tower design equation of Equation (4).

$$Z = \frac{{G}_{s}}{{K}_{y} * a} {\int }_{{Y}_{2}}^{{Y}_{1}} \frac{dY}{Y - {Y}^{*}} \qquad ( 4 )$$

where Gs represents molar flow of solute-free gas per cross-sectional area of the column, a is the interfacial area available for mass transport, Ky accounts for overall gas phase mass transfer coefficient, Y is the fraction of moles of gas phase solute per moles of solute-free gas, and Y* denotes the gas phase mole fraction in equilibrium with the liquid phase. The denominator of the integral represents the driving force for mass transfer and is integrated over the condition of the gas phase from the top to the bottom of the column.

Given that the interfacial area a is in the denominator of the design equation, it is advantageous to have a large amount of interfacial area within the scrubbing column.

### Materials and Methods

CO₂ Absorption Experiments without Frother Addition

The mini-pilot scale setup shown in FIG. 2 was used to conduct experiments on percentage of CO₂ absorbed with sodium carbonate and other reagents. The packed-bed absorption column (Height: 274.3 cm, Diameter: 10.16 cm; Packing: Polypropylene pall rings 1.2 cm×1.2 cm; Packed bed height: 121.92 cm) shown on the left side in FIG. 2 is used as a counter current absorption column. The top portion of the capture column (213.36 cm) is made of see through polyacrylic plastic and the bottom portion is made of steel to ensure robustness. For the absorption experiments Na₂CO₃ (99.8% pure) was obtained from Duda Energy while NaOH (99%) and MEA (reagent grade) were obtained from Sigma-Aldrich. The CO₂ gas cylinders (99% pure) were obtained from Grainger. In order to simulate the flue gas, a gaseous mixture containing 16% by volume CO₂ and rest air was continuously fed into the bottom of the scrubbing column with the help of a gas diffuser. Gas flow rate was maintained at 21 LPM. Separate flow meters were installed for CO₂ and air to measure the volumetric flow and to control the percentage of CO₂ in the gas stream. CO₂ and air flow rates were measured with gas flow meters (OMEGA) equipped with gas controllers (McMaster-Carr). One of ordinary skill will appreciate that this gaseous mixture inlet could be replaced with the actual flue gas of a power plant.

The percentage CO₂ of the simulated flue gas exiting out from the top of the column was measured with Quantek Model 906 infrared gas analyzer calibrated with a 20-vol % CO₂/N₂ reference gas. Several flow rates (3-10 Liters per minute) were tested for the aqueous solutions of Na₂CO₃, NaOH and MEA. The data on percentage of CO₂ absorbed was continuously recorded by the data logger connected to the gas analyzer. After each experiment the data logger was connected to the computer and the graph generated from it was integrated to calculate the total moles of CO₂ absorbed per minute. The accuracy of the data was ensured by repeating these experiments in triplicates. For a 16% CO₂ gas stream (simulating a power plant flue gas) the optimum parameters were found to be: 0.2 M sodium carbonate solution at 7.5 Liters per minute flow rate. The effect of temperature on absorption efficiency was also studied by heating the scrubbing solution with immersion tank heater to vary the temperature of the Na₂CO₃ solution from 25° C. to 60° C. The CO₂ was regenerated along with the scrubbing solution as shown in FIG. 2 and was again recycled through the scrubbing column. Table 2 shows the typical operating conditions for the CO₂ scrubbing and regeneration setup.

TABLE 2
Typical operating parameters for the
scrubbing setup shown in FIG. 2.

| Experimental Conditions | | |
|---|---|---|
| Scrubbing solution flowrate | 7.5 | L/min |
| Gas inlet temperature | 31° | C. |
| Scrubbing solution inlet temperature | 38.5° | C. |
| Column operating pressure | 101.325 | kPa |
| Liquid/gas-ratio (Kg/Kg) | 4.3 | |
| Gas composition | 16% vol CO₂, rest air | |
| Desorption temperature | 98° | C. |

CO₂ Absorption Experiments with Frother Addition

A frothing agent was added in trace amounts to Na₂CO₃ slurry scrubbing solutions to create small and uniform bubbles when air was introduced into the liquid solution. Several different frothing agents were tested at varying concentrations from 5 ppm to 20 ppm at 5 ppm increments, as provided in Table 3. Absorption efficiency of frother-modified sodium carbonate solution was recorded at regular intervals of time. The frothers were obtained from Cytec Solvay group. Although prices of most of these frothers are unknown, it was estimated from known sources that the frothing agent price was around 1.2-1.4$/Kg.

TABLE 3
Type of frothing agent used and related properties.

| Frothing | | Frother | Molecular | Molecular |
|---|---|---|---|---|
| Agent | Manufacturer | Type | Formula | Weight |
| DF200 | DOW Chemical | Polyglycol | CH₃(C₃H₆O)₃OH | 206.29 |
| DF250 | DOW Chemical | Polyglycol | CH₃(C₃H₆O)₄OH | 206.29 |
| DF400 | DOW Chemical | Polyglycol | H(C₃H₆O)_{6.5}OH | 206.29 |
| AF68 | Solvay | Polyglycol | (mixture) n/a | — |
| AF70 | Solvay | Alcohol | (CH₃)₂CHCH₂CHOHCH₃ | 102.17 |

### Reagent Regeneration and Heat Duty

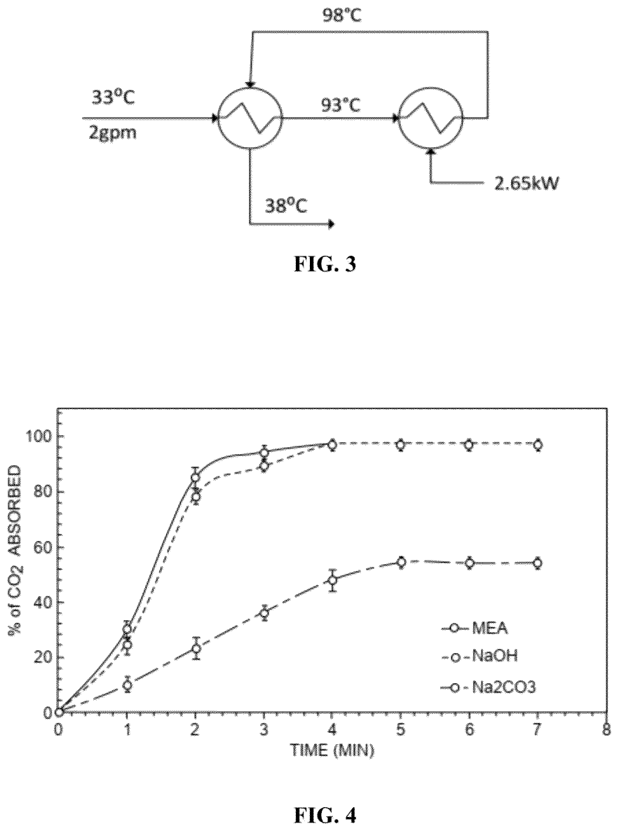

The means for regeneration can comprise a reagent regeneration setup (CO₂ stripper) consisting of a series of heat exchangers accompanied by a 19 Liter flash drum and a condenser. An exemplary overall heat recycle loop is provided in FIG. 3. The waste heat is reused with the help of heat exchangers for the thermal regeneration setup. Looking at the regeneration system energetically, the heat required to heat the inlet is already present in the outlet, such that the heat that needs to be added should be no more than required to make up the heat lost due to entropy. This should allow a significant reduction in the energy cost from 90 kWhr/m3 to about 3 kWhr/m3 to about 7 kWhr/m3. The total regeneration energy is calculated based on energy provided and also enthalpy change (ΔH) of the reagent used.

### Experimental Procedure

The setup shown in FIG. 2 was used to conduct continuous CO₂ capture and regeneration experiments. The experiment was started by turning the gas on with 16% volume CO₂ with the remaining comprising air in order to simulate flue gas. Once the gas analyzer started recording the CO₂ data, a sodium carbonate solution from a reserve tank (now shown-100 Liter) was pumped to the top of the scrubbing column as the slurry solution at 7.5 Liters per minute flow rate, and CO₂ absorption data was continuously recorded by data logger on the gas analyzer. After 5 minutes from start, the CO₂ absorption reached steady state, and then the bicarbonate solution coming out of the scrubbing column deposited in the bicarbonate reserve tank (not shown) was sent through the desorption setup for regeneration and the desorbed solution (e.g., regenerated sodium carbonate solution) was pumped back into the sodium carbonate reserve tank. The entire CO₂ absorption and desorption setup was then continuously run for 2 hours to ensure no discrepancy. The CO₂ absorption data was continuously recorded by the gas analyzer for 2 hours and no decrease in absorption rate was observed for the entire experiment. Each experiment was repeated three times to ensure reproducibility.

### Results and Discussion

The gas analyzer continuously measured the percentage concentration of the CO₂ being fed into and exiting out from the top of the scrubbing column. The absorption efficiency of CO₂ (as % of CO₂ absorbed) was calculated by Equation (5):

$$Absorption efficiency ( or ) \% of CO absorbed = \frac{{X}_{in} - {X}_{out}}{{X}_{in}} \times 100 \qquad ( 5 )$$

where Xᵢₙ is number of moles of the gas going into the scrubbing column and Xₒᵤₜ is number of moles of the gas coming out of the scrubbing column.

Initial experiments were conducted on Na₂CO₃ solution as the scrubbing slurry solution, without the addition of any frother to compare the CO₂ absorption efficiency of Na₂CO₃ with that of MEA and NaOH as the scrubbing solutions. Later, various frothers were added to the Na₂CO₃ scrubbing solution at 5 ppm incremental concentrations. Adding a frothing agent improved the absorption efficiency of Na₂CO₃ solution from 55.6% to 99.9%. The 99.9% absorption efficiency removal is based on 0.05 to 0.1% instrument error of the gas analyzer. Based on the work of Mai et al. on vapor-liquid equilibria for carbonate-bicarbonate-water-CO₂ system at 101 kPa and 38° C., the experiments stayed on the lower end of the sodium carbonate concentrations (0.1-0.3 mol/L) for conducting CO₂ absorption. Depending on the molar ratio of CO₂ converted and sodium carbonate (0.2 mol/L) used, the fraction of sodium carbonate converted to bicarbonate is only 0.46 without the frothing agent, which is believed to be due to slower absorption kinetics. After the addition of the respective frothing agent, the conversion increased to 0.81, which corresponds to a 43.2% increase.

The experimental uncertainty was calculated and error bars were plotted within the 95% confidence interval for all the experiments. These results are discussed in detail below:

Absorption Results without the Addition of a Frothing Agent

Based on Equation (5) above, the percentage of CO₂ absorbed was calculated from start of the experiment until it reached steady state and a maximum absorbance as shown in FIG. 4. Initial experiments were conducted with NaOH, monoethanolamine (MEA) and Na₂CO₃ on the scrubbing column of FIG. 2 to compare the reagents for CO₂ capture efficiency. Experimental results suggest that the absorption efficiency of amines and NaOH are almost the same, while the absorption efficiency of Na₂CO₃ is much less compared to the other two. The absorption efficiency of these reagents were noted at a concentration of 0.1 M, 0.2 M and 0.3 M in water, with 2-3% uncertainty.

The percentage of CO₂ absorbed at 0.1 M concentration for NaOH and MEA was almost the same at about 95% absorption efficiency, but the absorption efficiency for Na₂CO₃ was only between about 30% and about 40%. The curves in FIG. 4 show the percentage of CO₂ absorbance for all three reagents MEA (top), NaOH (middle) and Na₂CO₃ (bottom), each reagent solution at 0.2 M concentration. With the increase in concentration from 0.1 M to 0.2 M, the percentage of CO₂ absorbed for NaOH and MEA increased from about 95% to about 97%, and the absorption efficiency for Na₂CO₃ increased from about 40% to about 55.6%. Each of the three reagents as slurry solutions were also tested at 0.3 M concentration in solution, but no further increase in absorption was observed.

### Effect of Temperature on Absorption Efficiency

Previous studies suggest that a temperature range of 30° C. to 40° C. is optimum for CO₂ absorption with sodium carbonate slurry. Studies conducted at MTU indicate that with increased temperature, the absorption rate of CO₂ decreases.

As the temperature was increased from 25° C. to 60° C., the rate of absorption of CO₂ decreased by 55%. It is believed that the reason for decrease in absorption efficiency at higher temperatures is because of decrease in gas solubility at elevated temperatures. Van′t Hoff's equation, which is provided in Equation (6) is believed to explain the effect of temperature on the solubility of gas.

$${k}_{H} = {k}_{H}^{°} exp [ \frac{- Δ {H}_{solution}}{R} ( \frac{1}{T} - \frac{1}{T °} ) ] \qquad ( 6 )$$

$$C = {k}_{H} \times ( P ) \qquad ( 7 )$$

k_{H}°—Henry's coefficient units-mol/L atm
ΔHₛₒₗᵤₜᵢₒₙ—Enthalpy of the solution units-Joules/mol
T—Slurry temperature units-K
R—Universal gas constant units-Joules/mol K
T°—298 K
C—CO₂ Concentration in the solution units-mol/L
P—Partial pressure of CO₂ in gas phase units-atm
k_{H}—Henry's Law constant units-mol/L atm

With increase in temperature, from Equation (6), k_{H} should decrease. Hence, according to Henry's Law (Equation (7)), the dissolved CO₂ in solution will decrease. Therefore, the rate of CO₂ absorption decreases at higher temperatures. The optimum temperature was observed to be around 30° C. to 39° C.

Addition of Frothers for Improving Rate of Absorption of Na₂CO₃ Slurry

Without wishing to be bound by theory, it is believed that adding a frothing agent modifies the bubble surface of the absorbent solution when gas is introduced. A frothing agent generates smaller and more uniform bubble sizes, which increases the surface area of contact between the gas and liquid improving mass transfer. This improves the absorption efficiency of the scrubbing solution significantly.

The rate at which CO₂ is absorbed into carbonate solutions can be described as provided in Equation (8):

$${R}_{CO 2} = - \frac{d [ {CO}_{2} ]}{dt} = {k}_{L} a ( {c}^{*} - c ) = k [ {CO}_{2} ] \qquad ( 8 )$$

where k_{L} is mass transfer coefficient and k is the rate constant assuming first order kinetics. Rate of absorption of CO₂ is proportional to gas liquid interfacial area a, as shown in Equation (8). Increasing the interfacial area available for mass transport is advantageous for a scrubbing solution with slower absorption kinetics. The addition of a frothing agent to the scrubbing solution allows a stable bed of small bubbles to form within the column, increasing the area of gas-liquid interface within the column. This effectively makes up for the low CO₂ absorption rate of sodium carbonate slurry.

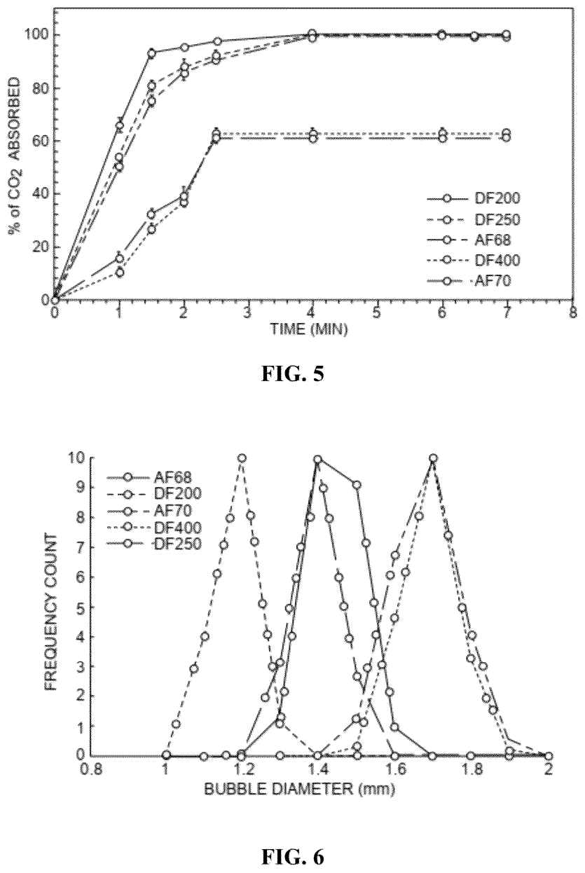

The data provided in FIG. 5 clearly shows that enhancing the sodium carbonate solution with an appropriate frothing agent greatly increases CO₂ absorption efficiency. The percentage of CO₂ absorbed was recorded from start of the experiment and was continued to be recorded after reaching steady state as well. Initially it took time for the bubbles to develop, but after reaching steady state the process was continuous. The frother-enhanced sodium carbonate solution was able to increase the CO₂ absorption efficiency of sodium carbonate solution from about 55.6% to 99.9%, which is greater than the absorption performance achieved by NaOH and MEA. FIG. 5 illustrates that the percentage of CO₂ absorbed reaches 99.9% with the frothing agent being DF200, DF250, and AF68. The frothing agents DF400 and AF70 were only able to increase the percentage of CO₂ absorbed from about 55.6% to about 62.8%. It is believed that these lower percentage of CO₂ absorbance can be attributed to the frothing agent AF70 (methyl isobutyl carbinol (MIBC)) is a weak frother, and that the frothing agent DF400 produces larger bubbles compared to the other polyglycol ether frothers (polyglycols). The effect of bubble size on CO₂ absorbance is discussed below.

### Bubble Size Analysis

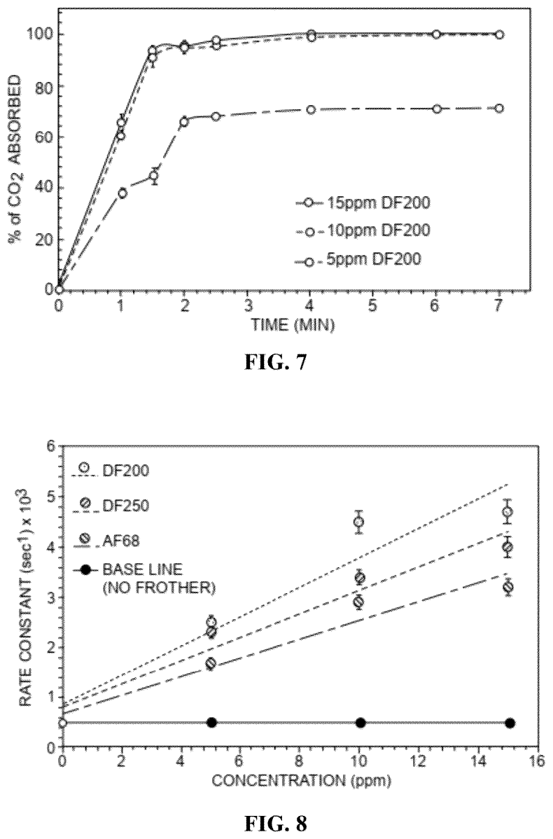

Pictures of the bubbles in the column were captured using a digital video camera (Sony Alpha A7 ll). The column was illuminated to avoid unnecessary shadows. High shutter speeds were used to avoid blurring. These pictures were processed by edge detection in MATLAB to determine the bubble size distribution. The effect of frothers on bubble size is shown at 10 ppm concentration in FIG. 6, which provides the estimated bubble size distribution for each individual frothing agent.

From FIG. 6 it can be noted that for polyglycol type frothing agents, bubble size increases with increasing molecular weight or chain length of the frother. This coincides with other studies indicating a similar trend. It is also noted that MIBC generates larger bubbles than polyglycols at the same frother concentration, which is also shown in FIG. 6. The frothing agent DF200 gave a narrow size distribution with smaller bubble size, making it ideal for this process. Although frothing agents DF250 and AF68 have the same size range, frothing agent AF68 has a wider bubble size distribution, which makes its initial CO₂ absorption efficiency slightly less than frothing agent DF250, which is also observed in FIG. 5. Frothing agents DF400 and AF70 gave similar bubble size distributions but with larger bubble size, making the effective mass transfer area less, which is reflected in the percentage of CO₂ absorption efficiency in FIG. 5.

### Effect of Frother Concentration on CO₂ Absorption

Various concentrations of frothing agents DF200, DF250 and AF68 were tested to study the effect of frother concentration on absorption performance. Since frothing agent DF200 gave the best absorption performance, three different concentrations (5 ppm, 10 ppm and 15 ppm) of frothing agent DF200 is shown in FIG. 7. The frother concentration of 10 ppm was determined to be the optimum dosage for frothing agent DF200. The data suggests that a solution enhanced with less frothing agent requires slightly more time for the amount of CO₂ in the exhaust stream to reach its minimum. This is believed to be due to the amount of time required for stable bubble formation. The froth forms very readily when larger concentrations of frothers are used in the scrubbing solution. For very short batch processes, using a higher concentration of frother is advantageous, as it captures slightly more CO₂ during the early stages of the process. During longer absorption periods, or continuous process, the difference in the bubble building period becomes negligible. With the addition of 10 ppm of the frothing agent DF200, the scrubbing efficiency of sodium carbonate slurry reached 99.9% after reaching steady state, and any further addition of the frother resulted in only very minimal improvements.

Foaming is usually observed when higher concentrations (more than 15 ppm) of surfactants are used. Thus, the tests were restricted to a concentration range of 5-20 ppm of the frothing agent. With lower concentrations, the frothers are aimed towards generating uniform bubble characteristics rather than stable froth/foam formation. Using too high of a concentration of the frothing agent may cause adverse effects such as foaming, where the gas gets completely trapped in the bubble swarm. Table 4 compares the CO₂ capture efficiency of different reagents with frother enhanced sodium carbonate solution.

TABLE 4
Effect of solvent type on CO₂ capture efficiency.

| | CO₂ capture |
|---|---|
| Absorbent | efficiency (%) |
| 0.2M Na₂CO₃ | 55.60 |
| 0.2M NaOH | 97.01 |
| 0.2M MEA | 97.12 |
| 0.2M Na₂CO₃ + 10 ppm | 99.90 |
| DF200 frothing agent | |

### Absorption Kinetics

The rate of the absorption reaction was estimated by calculating the slope between the number of moles of CO₂ absorbed versus time. The number of moles absorbed was calculated by performing trapezoidal integration on the graph generated by the data logger on the gas analyzer. The rate constant was estimated from Equation (8), assuming first order kinetics based on the work of Sharma and Danckwerts. The rate constant is directly correlated to the rate of absorption. From FIG. 8, it is evident that rate of absorption is highest with the frothing agent DF200, closely followed by frothing agents DF250 and AF68, which are all polyglycols. Compared to the baseline, these three frothers increased the absorption rate of Na₂CO₃ solution significantly. Though sodium carbonate solution by itself has a lower absorption efficiency than NaOH or MEA, the addition of a frothing agent increased the absorption efficiency of Na₂CO₃ above NaOH and MEA. Additionally, the frother is expected to have no impact on the energy cost of regeneration.

### Reagent Regeneration

Reagent regeneration energy was estimated from the heat duty (2.65 kwh) from heat recycle loop shown in FIG. 3. With 1.13 mol per minute of CO₂ absorbed, heat requirement for the frother-enhanced Na₂CO₃ was around 3.18 MJ/KgCO₂. The frothers had no impact on the energy of the reagent regeneration, perhaps because of their very low concentrations. The typical regeneration energies for MEA-based CO₂ capture have been reported to be around 3.9-4.3 MJ/KgCO₂. The energy consumption utilizing a frother-modified dilute sodium carbonate solution based system was much lower than the MEA based system. Thus, it is believed that using a frother-enhanced dilute sodium carbonate solution based system will reduce the reagent cost and also other operating costs for post-combustion CO₂ capture. The concentration of 10 ppm of the frothing agent DF200 gave the best results among other frothing agents. Originally, increasing frother concentrations increased the absorption rate as seen in FIGS. 7 and 8, but over longer trials and after reaching steady state, this gap was negligible. Owing to the very low concentration of the frothing agents used, the solvent regeneration energy remained essentially the same as a sodium carbonate solution without any frothing agent.

While the frothing agents were observed to degrade at various points throughout the system after 3-4 cycles, a fresh batch of the frothing agent was added after every 3 cycles. It is contemplated that the sodium carbonate solution can be periodically dosed with a frothing agent to address the frothing agent degradation. In some other preferred aspects, a small dose of the frothing agent may be continually added to the sodium carbonate solution to maintain approximately the desired concentration of the frother-modified sodium carbonate solution based system.

The frothing agents did not enter the CO₂ rich stream when the sodium carbonate and CO₂ was regenerated from the sodium bicarbonate, which is believed to be due to their high decomposition temperature being between about 200° C. and about 250° C. compared to the desorption temperature of the system being between about 80° C. and about 110° C., more preferably between about 85° C. and about 105° C., and even more preferably between about 95° C. and about 100° C.

Before any discharging of process water, the organic nature of the frothing agents allows their easy removal with activated carbon, because of their hydrophobicity. A complete guide on low cost flotation frothers treatment methods was reviewed by Li et al. in 2019. Considering the recyclability and based on costs from Table 1 of the Li et al. article, the reagent cost for CO₂ capture could be reduced by at least 50%, in some aspects at least 55%, in some aspects at least 60%, in some aspects at least 65%, in some aspects at least 70%, in some aspects at least 75%, and in some other aspects up to about 78%, by switching to a frother-enhanced sodium carbonate system.

Although amines and NaOH have a very high CO₂ capture efficiency, there are some drawbacks associated with both the reagents including equipment corrosion, solvent degradation, high cost, and so on. The frother-enhanced sodium carbonate system of the present invention enhances the absorption performance of already existing low-cost sodium carbonate solutions while providing an environmentally friendly and non-corrosive solution.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features: rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A scrubbing solution capable of capturing carbon dioxide from a gaseous feedstock, the scrubbing solution comprising:
a slurry scrubbing solution comprising a sodium carbonate solution mixed with at least one frothing agent mixed, wherein the at least one frothing agent comprises at least one compound of Formula (I): 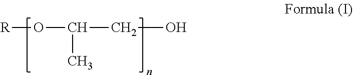
wherein R is H or CH₃, and wherein n is greater than 2 and up to 34, preferably n being between 3 and 34, more preferably n being between 3 and 8;
wherein the at least one frothing agent present within the slurry scrubbing solution enhances the absorption rate of carbon dioxide from a gaseous feedstock by the slurry scrubbing solution to produce a resultant product compared to the absence of the at least one frothing agent within the slurry scrubbing solution.

2. A scrubber system capable of capturing carbon dioxide from a gaseous feedstock, the scrubber system comprising:
a scrubbing assembly comprising a scrubbing column, a slurry scrubbing solution and a gaseous feedstock;
wherein the scrubbing column having a gaseous feedstock inlet, a gas outlet, a slurry scrubbing solution inlet, and a resultant product outlet, wherein the scrubbing column comprises a counter current absorption column;
wherein the slurry scrubbing solution introduced into the scrubbing column proximate the slurry scrubbing solution inlet in a first flow direction, wherein the slurry scrubbing solution capable of capturing carbon dioxide from a gaseous feedstock introduced into the scrubbing column proximate the gaseous feedstock inlet in a second flow direction, such that the first flow direction of the slurry scrubbing solution within the scrubbing column is a counter-current direction than the second flow direction of the gaseous feedstock within the scrubbing column;
wherein the slurry scrubbing solution comprising a sodium carbonate solution mixed with at least one frothing agent mixed, wherein the at least one frothing agent comprises at least one compound of Formula (I): 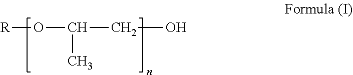
wherein R is H or CH₃, and wherein n is greater than 2 and up to 34, preferably n being between 3 and 34, more preferably n being between 3 and 8;
wherein the at least one frothing agent present within the slurry scrubbing solution enhances the absorption rate of carbon dioxide from a gaseous feedstock by the slurry scrubbing solution to produce a resultant product compared to the absence of the at least one frothing agent within the slurry scrubbing solution.

3. A method of capturing carbon dioxide from a gaseous feedstock, the method comprising:
feeding a gaseous feedstock into a scrubbing assembly comprising a scrubbing column a slurry scrubbing solution, the gaseous feedstock fed into the scrubbing column proximate a gaseous feedstock inlet, wherein the gaseous feedstock comprises carbon dioxide, wherein the scrubbing column comprises a counter current absorption column;
feeding the slurry scrubbing solution into the scrubbing column proximate a slurry scrubbing solution inlet in a second flow direction, wherein the slurry scrubbing solution comprising a sodium carbonate solution mixed with at least one frothing agent mixed, wherein the at least one frothing agent comprises at least one compound of Formula (I): 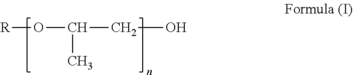
wherein R is H or CH₃, and wherein n is greater than 2 and up to 34, preferably n being between 3 and 34, more preferably n being between 3 and 8;
flowing the gaseous feedstock within the scrubbing column in a first flow direction and the slurry scrubbing solution within the scrubbing column in a second flow direction, wherein the first flow direction of the gaseous feedstock is a counter-current flow to the second flow direction of the slurry scrubbing solution, such that the slurry scrubbing solution captures carbon dioxide of the gaseous feedstock to produce a result product;
wherein the at least one frothing agent present within the slurry scrubbing solution enhances the absorption rate of carbon dioxide from a gaseous feedstock by the slurry scrubbing solution to produce the resultant product compared to the absence of the at least one frothing agent within the slurry scrubbing solution.

4. The system of claim 2, wherein the resultant product comprises sodium bicarbonate solution.

5. The system of claim 2, wherein the gaseous feedstock comprises a flue gas, such that the slurry scrubbing solution captures carbon dioxide from the flue gas.

6. The system of claim 2, wherein the gaseous feedstock comprises a flue gas resulting from combustion of a fossil fuel, wood, or a renewable power source, such that the slurry scrubbing solution captures carbon dioxide from the flue gas.

7. The system of claim 2, wherein the at least one frothing agent in the slurry solution increases the absorption rate of carbon dioxide compared to the absence of the at least one frothing agent in the slurry solution.

8. The system of claim 2, wherein the at least one frothing agent has a molecular weight (g/mol) less than about 400.

9. The system of claim 8, wherein the at least one frothing agent has a molecular weight (g/mol) greater than 200 and less than about 260.

10. (canceled)

11. The system of claim 2, wherein the at least one frothing agent comprises at least one PEG-based compound chosen from the group consisting of CH₃(C₃H₆O)₃OH, CH₃ (C₃H₆O)₄OH, CH₃(C₃H₆O)_{6.3}OH, CH₃(C₃H₆O)₃OH, H(C₃H₆O)_{6.5}OH, H(C₃H₆O)₆OH, CH₃(C₃H₆O)₄OH(C₄H₈O), H(C₃H₆O)_{12.8}OH, H(C₃H₆O)_{16.5}OH, H(C₃H₆O)₃₄OH and mixtures thereof.

12. (canceled)

13. The system of claim 2, wherein the at least one frothing agent is capable of producing gaseous carbon dioxide having an average bubble diameter size in the slurry scrubbing solution of less than 1.8 mm.

14-15. (canceled)

16. The system of claim 2, wherein the at least one frothing agent is present in the slurry scrubbing solution in an amount between about 5 ppm and about 20 ppm.

17-20. (canceled)

21. The system of claim 2, wherein the resultant product comprises a sodium bicarbonate solution; wherein the sodium bicarbonate solution can be subjected to a regeneration process to provide a regenerated sodium carbonate solution and a regenerated carbon dioxide.

22-23. (canceled)

24. The system of claim 21, wherein the regenerated carbon dioxide has a purity greater than 95%.

25. The system of claim 2, wherein the regenerated sodium carbonate solution is separated from the regenerated carbon dioxide.

26. The system of claim 2, wherein the regenerated sodium carbonate solution is recycled through the scrubbing column for additional capture of carbon dioxide from the gaseous feedstock.

27. The system of claim 26, wherein the regenerated sodium carbonate solution is capable of reacting with the carbon dioxide of the gaseous feedstock fed into the scrubber column to provide a second resultant product comprising a sodium bicarbonate solution.

28. The system of claim 2, wherein the slurry scrubbing solution is capable of being used in a continuous process comprising one or more regeneration cycles of a regenerated slurry scrubbing solution.

29. The system of claim 2, wherein the regenerated slurry scrubbing solution comprises a regenerated sodium carbonate solution and at least a portion of the frothing agent.

30. (canceled)

31. The system of claim 2, wherein the frothing agent concentration is replenished in the sodium carbonate solution on a continuous dosing basis.

32-34. (canceled)

35. The system of claim 2, wherein the slurry scrubbing solution is capable of capturing carbon dioxide from the gaseous feedstock in amount of at least 90%.

36-38. (canceled)
